(19) United States
(12) Patent Application Publication
(10) Pub. No.: US 2015/0009732 A1
(43) Pub. Date: Jan. 8, 2015

(54) CONTROL UNIT FOR AN INVERTER LOADED BY A RESONANT LOAD NETWORK

(71) Applicant: Paul Vahle GmbH & Co., KG, Kamen (DE)

(72) Inventors: Faical Turki, Bergkamen (DE); Thomas Vosshagen, Drolshagen (DE)

(21) Appl. No.: 14/366,401

(22) PCT Filed: Dec. 19, 2012
(86) PCT No.: PCT/EP2012/076217

§ 371 Date: Jun. 18, 2014

(30) Foreign Application Priority Data
Dec. 22, 2011 (DE) 10 2011 122 103.8

(51) Int. Cl. H02M 7/5387; H02M 7/538

(52) U.S. Cl. CPC H02M 7/53871; H02M 7/53803
USPC 363/97

(57) ABSTRACT

An inverter may include at least two switching means for feeding a series oscillator circuit from a source, wherein a control device of the inverter controls the switching means in such a way that: in a first mode A, the inverter feeds the oscillator circuit via the switching means from the source; and in a second mode B, the oscillator circuit is decoupled from the source, wherein the control device switches back and forth between the two modes A and B to set a reference current in the oscillator circuit or a reference voltage on the oscillator circuit.

The present invention relates to an inverter with at least two switching means for feeding an oscillator circuit from a source, wherein a control device of the inverter controls the switching means.

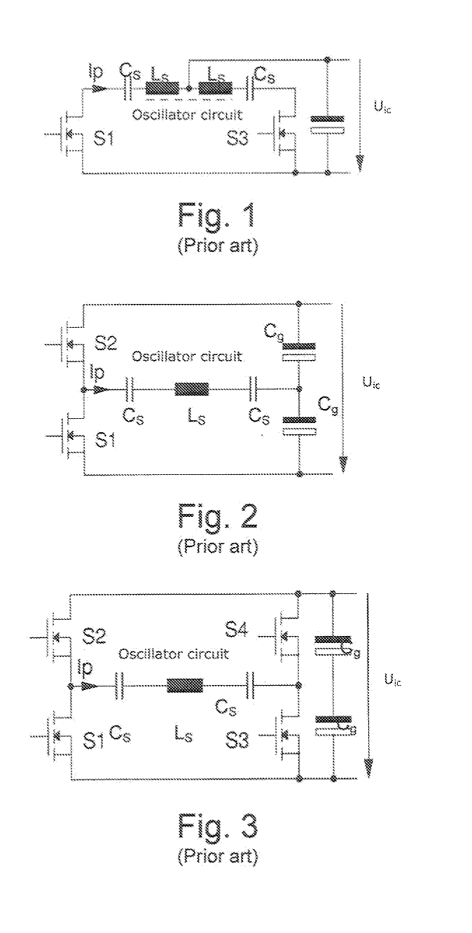

In modern inverter technology, resonant switching processes are increasingly used as switching relief of the power semiconductors. This results in lower switching losses and therefore improved overall efficiency also. If the inverters are loaded with a resonant load network, the oscillator circuit is active in the output circuit and not in the intermediate circuit of the inverter. FIGS. 1 to 4 show inverters which feed an oscillator circuit on the output side. As shown in FIG. 1, the inverter may be designed as a push-pull inverter. The inverter is fed here by means of the intermediate circuit voltage U_{ic}. However, the inverter may also be designed as a half-bridge inverter (FIG. 2) or as a full-bridge inverter (FIG. 3).

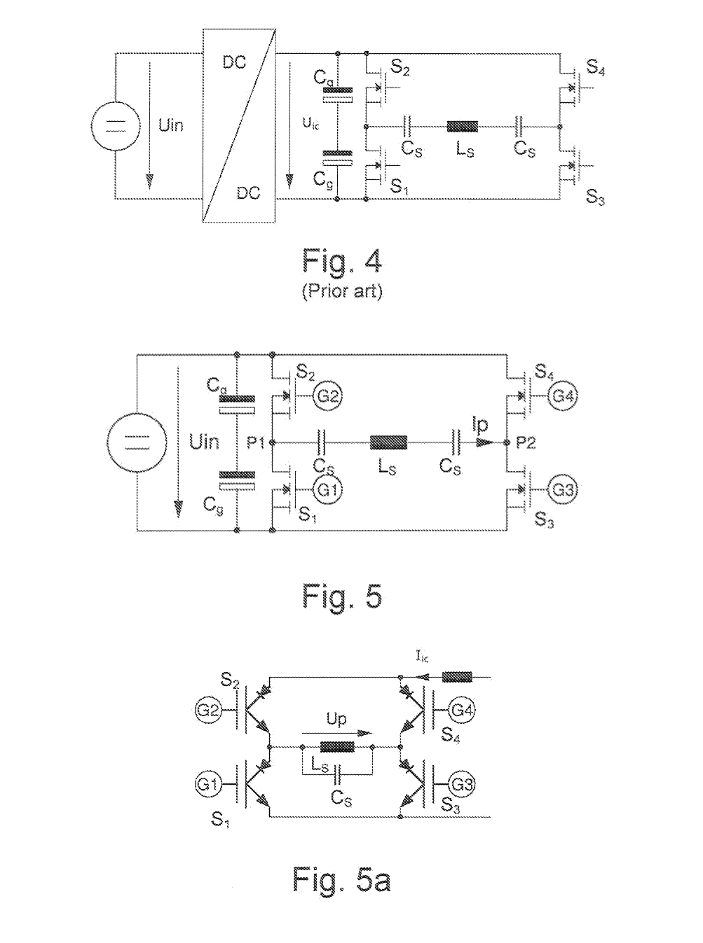

Various methods exist for feeding resonant loads by means of an inverter. A first method provides that the power semiconductors of the inverter are controlled at a fixed clock frequency. The clock frequency is selected in such a way that only the smallest possible switching losses occur. The operating point is preferably to be selected as slightly inductive. Provided that a series oscillator circuit is fed, the power semiconductors are activated only if their voltage is equal to zero, and are de-activated (ZVS) only if their current is more or less zero (ZCS). The disadvantage of this method is that only unfavourable facilities for control via the timing of the power semiconductors exist, since a pulse width modulation causes high switching losses. A further control facility exists in the variation of the intermediate circuit voltage U_{ic} of the feed-in inverter. The intermediate circuit voltage can be set e.g. by means of a DC/DC converter, as shown in FIG. 4.

In a second possible method, the output variable can be controlled via the clock frequency of the inverter. This method exploits the frequency dependence of the output-side oscillator circuit. The control device times the power semiconductors at a higher frequency than the resonant frequency so that inductive operation is always guaranteed. The disadvantage of this method is that, although activation takes place at ZVS, the power semiconductors must always de-activate a certain current, as a result of which switching losses occur.

A third possible method offers the advantage of an adaptation to changes in the transmission medium, such as e.g. a change in the inductances due to mechanical influence, ageing of the capacitors, heating, etc. Measurements must be performed which enable the time specifications of the timing. If a series oscillator circuit is used, it suffices to measure the output current and forward the latter as an inverted control signal to the power semiconductors. The 180° phase shift enables the oscillation build-up of the system.

In the previously described method, control is possible via the intermediate circuit voltage also, as a result of which, however, a further power stage in the form of a DC/DC converter must be connected upstream of the inverter, whereby the overall efficiency disadvantageously deteriorates.

A method is known from DE 101 15 326 for controlling de-activatable semiconductor switches in bridge arms of an inverter which serve to supply a parallel oscillator circuit connected to the input of the inverter, wherein the inverter is operated with an injected current and at least one diode is connected in series with the semiconductor switches. The method known from DE 101 15 326 uses a controller which sets an optimum phase angle so that voltage peaks occur on neither the semiconductor switches nor the series diodes.

The object of the present invention is to provide an inverter with a control device for the switching means of the inverter which are designed in particular as power semiconductors which, with the use of a constant source feeding the inverter, enables a control of the output variable in line with a nominal variable.

This object is achieved according to the invention in that the control device controls the switching means in such a way that, in a first mode A, the inverter feeds the oscillator circuit via the switching means from the source and, in a second mode B, the oscillator circuit is decoupled from the source, wherein the control device switches back and forth between the two modes A and B to adjust a desired current (Iₚ_{_{—}}_{ref}) in the oscillator circuit or a desired voltage (Uₚ_{_{—}}_{ref}) on the oscillator circuit.

The desired current if a series oscillator circuit is used or the desired voltage when a parallel oscillator circuit is used is set over the temporal duration of the two modes A and B, in particular over their pulse duty factor. The control device controls the switching means softly so that the temporal duration while one mode is active is equal to or longer than the period duration of the resonant frequency of the oscillator circuit. The switching frequency of the control signals controlling the switching means, in particular the gate signals, is dependent in mode A on the resonant frequency of the oscillator circuit, normally minimally greater than the resonant frequency. The control device or controller can be advantageously designed in such a way that the switching frequency at which the switching means are switched in mode A is determined by the frequency of the oscillator circuit.

The inverter can be implemented by means of a bridge circuit. This can be designed as a full-bridge or half-bridge or push-pull circuit. The switching means are disposed in its bridge arms, wherein the transverse arm is formed by the oscillator circuit. If a semi-controlled inverter is used, capacitors are to be provided in the uncontrolled bridge arms, as shown in FIG. 2.

If a series oscillator circuit is connected at the output of the inverter, the inverter is advantageously fed by a DC voltage source, in particular a voltage source with a constant output voltage. In this case, the current Iₚ flowing through the series oscillator circuit is controlled. A two-step controller, a PWM controller or a push-pull controller can be used as the controller. In mode A, the inverter operates normally, wherein the clock frequency of the switching means is predefined by the resonant frequency of the series oscillator circuit. If a two-step controller is used, the control device switches over to mode B as soon as the current Iₚ in the series oscillator circuit has exceeded a maximum value. In mode B, the series oscillator circuit is short-circuited over two bridge arms of the inverter and is thus decoupled from the voltage source feeding the inverter. The current in the series oscillator circuit thus freewheels in mode B over the two upper or two lower bridge arms of the full-bridge circuit of the inverter. If a primary oscillator circuit of an energy transmission system is fed by means of the inverter according to the invention, the resonant frequency of the series oscillator circuit changes with the width of the air gap and the secondary-side load. Depending on the secondary-side quality or load, the current decreases more or less quickly in the series oscillator circuit. As soon as the current in the series oscillator circuit has reached or fallen below a lower threshold value, the control device switches over once more to mode A. The changeover from one mode to the other advantageously involves soft switching, so that only low switching losses and interfering electromagnetic radiation arise.

If a parallel oscillator circuit is connected at the output of the inverter, the inverter is advantageously fed by a DC current source, in particular a constant current source. In this case, the voltage Uₚ decreasing on the parallel oscillator circuit is controlled. In mode A, the switching frequency of the switching means of the inverter similarly follows the frequency of the parallel oscillator circuit. After an upper voltage value has been exceeded, switchover to mode B takes place here also, so that the parallel oscillator circuit is no longer fed via the current source. For this purpose, the switching means must be switched for the duration of mode B in such a way that the current of the current source flows only through the bridge arm and the voltage freewheels in the parallel oscillator circuit.

The switching means are switched with the lowest possible loss. If a series oscillator circuit is used, the control device can advantageously be developed in such a way that the switching means are activated only if the voltage decreasing on them is equal to zero. The de-activation process is initiated or released only if the current through the respective switching means has fallen below a specific, in particular predefinable, threshold value. The threshold value is set either as a one-off by means of a calibration process in which the inverter is optimised in terms of e.g. optimum overall efficiency and/or low electromagnetic interferences. Due to the optimised threshold value, the phase angle between the current and voltage is set in such a way that the de-activation process is neither too inductive, and therefore no excessively high current needs to be switched, nor too capacitive, so that switching is not carried out too close to the current zero transition.

If a parallel oscillator circuit is used, all switching means are active, i.e. conducting, in the overlap time. While a diagonal pair of the switching elements in the form of controllable semiconductors is closed, the others are closed only if a negative voltage threshold value Uₜₕᵣₑₛₕ on them is exceeded. The switching elements are advantageously de-activated only if the current flowing in them is zero. This time arises when a positive voltage is measured on the switching elements. The preferred phase position is slightly capacitive. This produces an operating frequency f_{A} which is slightly greater than the resonant frequency f₀of the parallel oscillator circuit.

Due to the quality of the oscillator circuit, the abrupt change in the injected power during the changeover from one mode to the other is advantageously smoothed so that the load undergoes only a small subsynchronous ripple.

If a series oscillator circuit is used, at least the voltage decreasing on a switching means and the actual current I_{p-act} flowing through the oscillator circuit are measured. The measured variables form feedback variables for the control circuit while the desired current I_{p-ref} to be set forms the input variable of the controller.

If a parallel oscillator circuit is used, at least the voltage decreasing on a switching means and the actual voltage U_{p-act} decreasing on the oscillator circuit are measured. The measured variables form feedback variables for the control circuit while the desired voltage U_{p-ref} to be set forms the input variable of the controller.

One possible embodiment of the control device for a fully controlled full-bridge inverter with an output-side series oscillator circuit is explained below.

For each switching means of the inverter, the control device generates a control signal G1 to G4, e.g. by means of flip-flops. To do this, the voltage potentials on both end points P₁ and P₂ of the transverse arm or of the series oscillator circuit of the full bridge are determined and compared by means of comparators with a voltage threshold value U_{Pthresh} The output signals of the comparators serve to generate activation release signals. Depending on the activation release signal, the switching means concerned can be activated on the next voltage zero transition.

The de-activation release signals are generated in that the current I_{p-act} flowing in the series oscillator circuit is compared in comparators with the current threshold values I_{PosThresh} and U_{NegThresh}. An additional device also generates a blocking signal which ensures that a de-activation release signal can be generated only during the positive half-wave of the current and simultaneously negative increase in the current Iₚ, or a de-activation release signal can be generated only during the negative half-wave of the current Iₚ and simultaneously positive increase in the current Iₚ for the respectively conducting switching means. It is thus ensured by means of the blocking voltage that the generation of the de-activation release signal is generated only in the second half of a half-wave of the current Iₚ. The blocking signal can be implemented, for example, by means of a dead-time element or a device consisting of a series circuit comprising an integrator which integrates the current Iₚ and a downstream zero transition detection device.

Through the calibration to define an optimum current threshold value or optimum current threshold values I_{PosThresh} and U_{NegThresh}, the control device is optimised so that either efficiency is maximised and/or the level of electromagnetic interferences is minimised. Through the measurement and processing of the actual current I_{p-act} and the voltage potentials P₁ and P₂, the control signals G1 to G4 of the switching means are thus matched to the frequency of the series oscillator circuit, as a result of which the inverter frequency in mode A follows the resonant frequency of the series oscillator circuit.

The control device continuously compares the desired current I_{p-ref} to be set with the actual current I_{p-act} and generates a setting signal which, together with further control signals, serves to control the de-activation release of the two switching means which implement the freewheeling of the series oscillator circuit in mode B. As soon as the current I_{p-act} has exceeded a certain threshold value Iₚ₋ₘₐₓ, the two switching means are prevented from de-activation by means of corresponding de-activation release signals so that they implement the necessary bipolar short circuit wherein the series oscillator circuit freewheels over the switching means and the current in the oscillator circuit decreases. As soon as the actual current I_{p-act} has again fallen below a lower threshold value Iₚ₋ₘᵢₙ, a switchback to mode A is again effected. So that the correct polarity always prevails during the switchover to mode A, it is necessary for mode B to be maintained for integral oscillation periods. The shortest time for which mode A can be active is a half-oscillation period.

The inverter according to the invention is explained in detail below with reference to drawings and circuit diagrams, in which:

FIG. 1: shows a push-pull inverter according to the prior art for a resonant load;

FIG. 2: shows a half-bridge inverter according to the prior art for a resonant load oscillator circuit;

FIG. 3: shows a full-bridge inverter according to the prior art for a resonant load oscillator circuit which is controllable via the intermediate circuit voltage or e.g. PWM;

FIG. 4: shows a full-bridge inverter according to the prior art for a resonant load oscillator circuit, the intermediate circuit voltage U_{ic} of which is controlled by means of DC/DC controllers to control the load current Iₚ;

FIG. 5: shows a full-bridge inverter according to the invention for a series resonant oscillator circuit, of which the input voltage Uᵢₙ is constant and which controls the load current Iₚ via the mode changeover:

FIG. 5a: shows a full-bridge inverter according to the invention for a parallel resonant oscillator circuit, of which the input current I_{ic} is constant and which sets the voltage Uₚ present on the parallel oscillator circuit via the mode changeover;

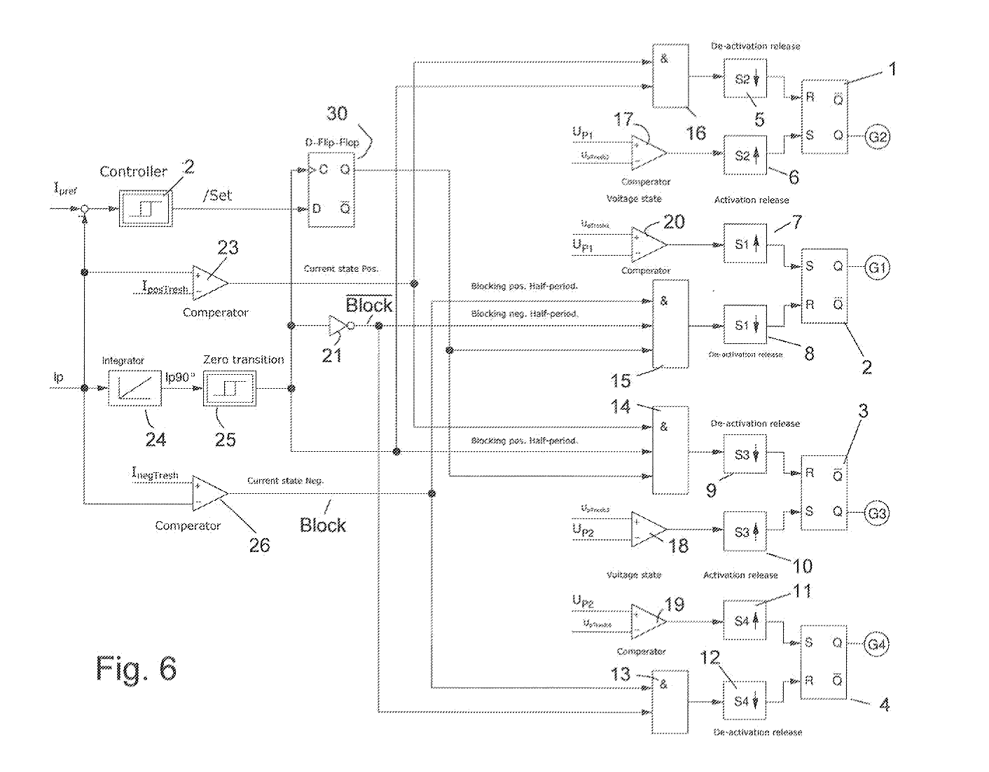

FIG. 6: shows a schematic diagram of a control device for the inverter according to the invention as shown in FIG. 5 with a series oscillator circuit;

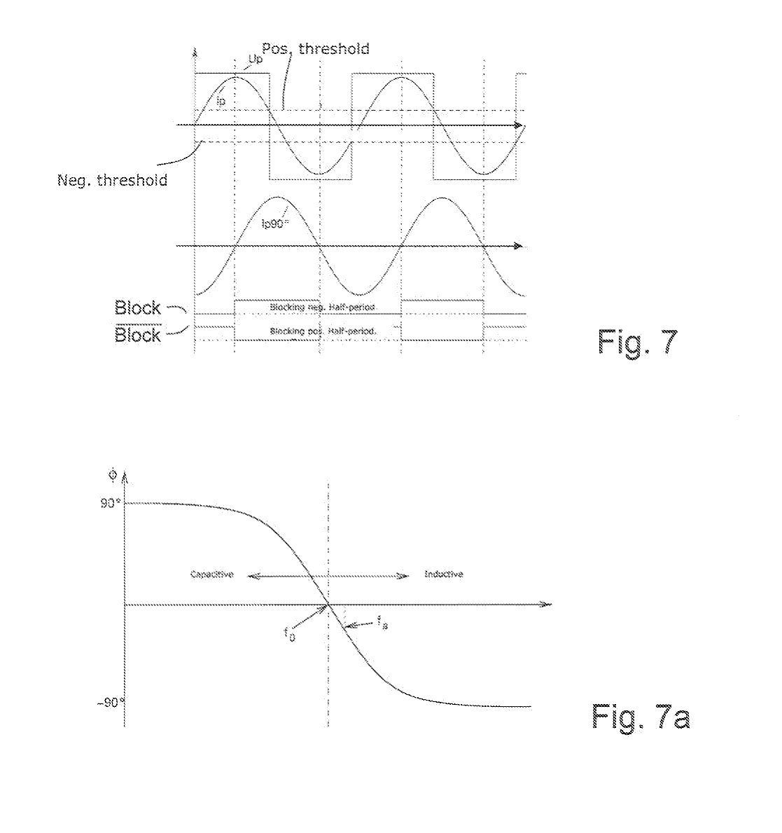

FIG. 7: shows the voltage and current characteristic at the output of the inverter according to the invention;

FIG. 7a: shows the phase response for a series oscillator circuit;

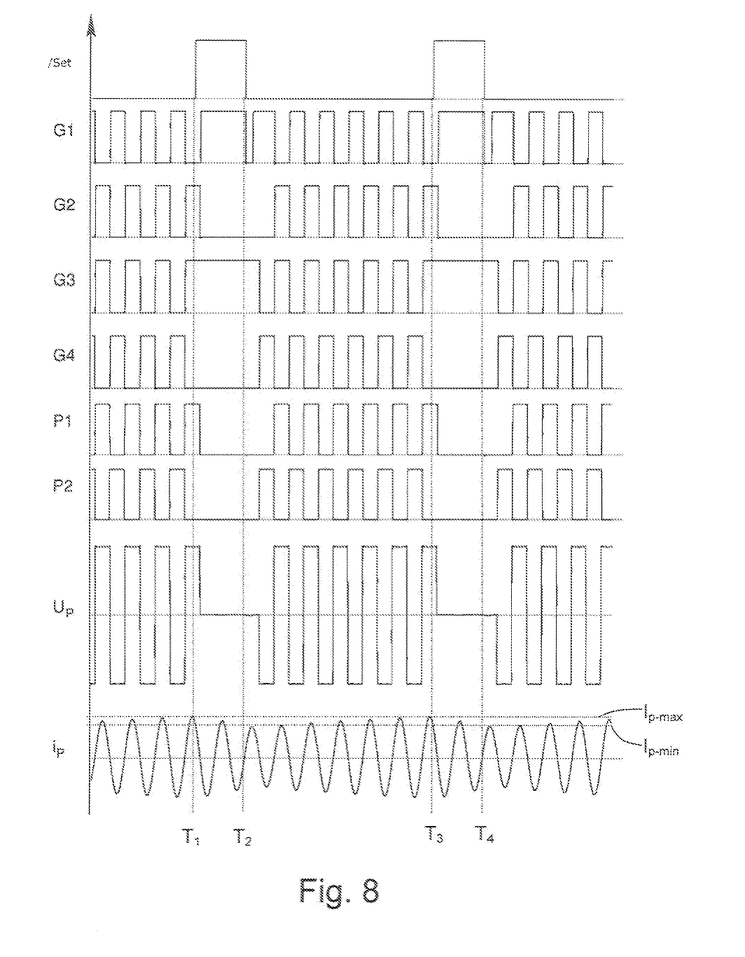

FIG. 8: shows the signal, voltage and current characteristics;

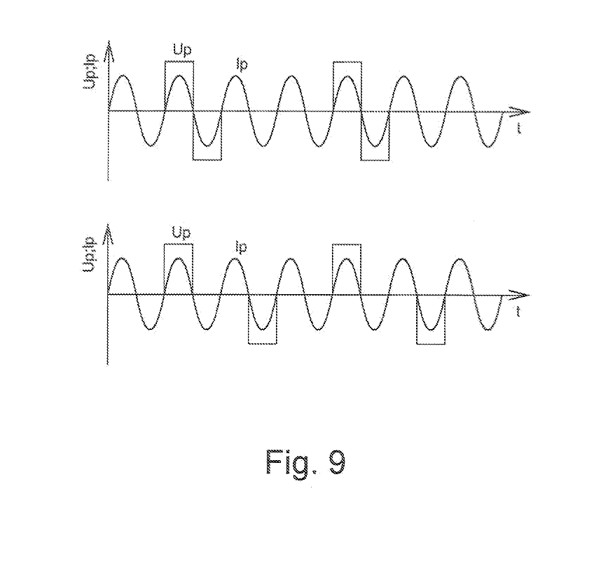

FIG. 9 shows the voltage diagrams for various timings of the modes A and B with the same pulse duty factor;

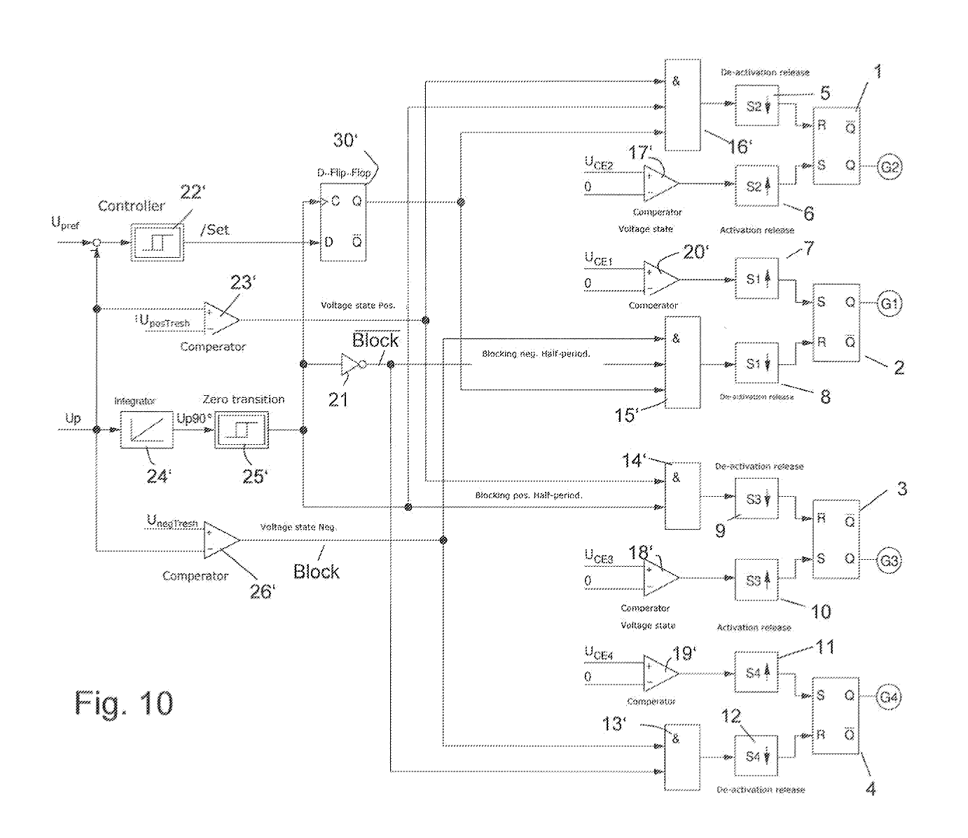

FIG. 10: shows a schematic diagram of a control device for the inverter according to the invention as shown in FIG. 5a with a parallel oscillator circuit.

FIGS. 1 to 4 show inverters according to the prior art. The inverters are designed for resonant load networks, wherein the output variable is set either via the controllable intermediate circuit voltage or by means of the clock frequency of the inverter. The inverters may be designed as push-pull, half-bridge or full-bridge inverters.

FIG. 5 shows a full-bridge inverter according to the invention for a series resonant oscillator circuit, of which the input voltage Uᵢₙ is constant and which sets the load current Iₚ via the mode changeover. The switching structures of the controlled full bridge and the series oscillator circuit essentially correspond to the structure known from the prior art. The inverter according to the invention differs from the known full-bridge inverters in that it is operated with a constant input voltage and the switching frequency of the semiconductor switches corresponds to the resonant frequency of the series oscillator circuit. The four switching means S₁, S₂, S₃ and S₄ disposed in the bridge arms are IGBTs which are controlled by the control signals G1 to G4 from the control device shown in FIG. 6. The points P1 and P2 form the output-side connection points for the series oscillator circuit which is formed by the capacitors C_{S} and the inductor L_{S}. The inductor L_{S} may be a primary-side coil for the energy transfer to a secondary-side oscillator circuit (not shown). The input voltage Uᵢₙ may be constant. However, it is also possible for the input voltage Uᵢₙ to be adjustable. However, this is fundamentally not necessary for the function of the inverter according to the invention, since the current Iₚ is controlled by the changeover between two modes, wherein, in the first mode A, the inverter operates normally as an inverter and feeds energy from the source Uᵢₙ to the oscillator circuit via the switching means S₁ to S₄ in synchronism with the resonant frequency of the oscillator circuit L_{S}-C_{S}, and, in the second mode B, short-circuits the series oscillator circuit either by means of the upper switching means S2 and S4 or by means of the lower switching means S1 and S3, so that the current Iₚ can freewheel over these switching means and thus decreases. During the short-circuit phase in mode B, the switching means respectively not involved in the short circuit must be opened so that the input voltage source Uᵢₙ is not short-circuited. The capacitors C_{g} serve to smooth the input voltage and are necessary for the commutation of the switching means. The voltage levels on the points P1 and P2 serve as input variables for the control device.

FIG. 5a shows the circuit diagram of the inverter according to the invention, if said inverter is loaded on the output side with a parallel oscillator circuit L_{S}-C_{S}. In contrast to the inverter with a series oscillator circuit, the voltage Uₚ present on the parallel oscillator circuit, rather than the current Iₚ, is set here by means of the reverse-blocking switching means S₁ to S₄. In this case, the inverter is fed by means of a constant current source which injects the current I_{ic}. In mode A, the inverter operates in its normal mode, wherein the control device is matched accordingly to the setting variable. In mode B, the parallel oscillator circuit is decoupled from the current source initially through the generation of a short circuit of the current source I_{ic} by means of a bridge arm S₁ and S₂ or S₃ and S₄. The switching means of the respective other bridge arm are then blocking, so that the parallel oscillator circuit can freewheel in mode B, as a result of which the voltage Uₚ temporally decreases. If a lower voltage threshold value Uₚ₋ₘᵢₙ is attained, switchback to mode A is again effected, wherein mode A is maintained until an upper voltage threshold value Uₚ₋ₘₐₓ is attained and switchback to mode B is effected.

FIG. 6 shows a schematic diagram of the control device for an inverter according to FIG. 5 which has a series oscillator circuit connected to it on the output side. The control device generates the gate signals G1 to G4 for the switching means S₁ to S₄. The gate signals G1 to G4 are generated by means of the flip-flops 1, 2, 3, 4 which are set or reset by means of the activation release signals (6, 7, 10, 11) and the de-activation release signals (5, 8, 9, 12). The de-activation release signals (5, 8, 9, 12) are determined by the characteristic of the current Iₚ, so that the gate signals G1 to G4 control the switching means S₁ to S₄ in synchronism with the current Iₚ. To do this, the control device has two comparators 23 and 26 which determine the current direction of the current Iₚ on the basis of the predefined threshold values I_{PosThresh} and I_{NegThresh}. The output of the comparator 23 which determines the positive current state of the current Iₚ is connected to the AND gates 14 and 16 which generate the de-activation release signals for the switches S₂ and S₃. The output of the comparator 26 which determines the negative current state of the current Iₚ is connected to the AND gates 13 and 15 which generate the de-activation release signals for the switches S₁ and S₄. The activation release signals (6, 7, 10, 11) are generated by the comparators 17 to 20, wherein the comparators 17-20 compare the voltage potentials U_{P1} and U_{P2} with the four threshold values U_{Pthresh1}, U_{Pthresh2}, U_{Pthresh3} and U_{PThresh4}. The respectively associated switching means S₁-S₄ are released for activation only if the voltage potentials Uₚ₁, and Uₚ₂ have fallen below the respective threshold value U_{PThresh,j}. However, it is also possible to provide two comparators only, one of which is responsible for generating the activation release signals of the switching means 1 and 2 and the other for generating the activation release signals of the switching means 3 and 4. Both comparators can compare the voltage potentials U_{P1} and U_{P2} with a U_{Pthresh} or against separate threshold values.

The current Iₚ is integrated by means of the integrator 24, as a result of which a signal Ip90° is generated which is processed by a zero transition detection element 25 to produce the blocking signal Block. The blocking signal Block is connected to an input of the AND gate 14 and an input of the AND gate 16. The blocking signal Block is simultaneously negated by means of the NOT gate 21 and is connected as _{B̅L̅O̅C̅K̅} to the inputs of the AND gates 13 and 15. The blocking signal Block and _{B̅L̅O̅C̅K̅} and the output signals of the comparators 23 and 26 are logically linked to one another by means of the AND gates 13, 14, 15 and 16 so that a de-activation release takes place for the respectively conducting switching means only if the current Iₚ has dropped below the threshold value I_{PosThresh} during the positive half-wave or has risen above the threshold value I_{NegThresh} during the negative half-wave. The phase angle for the de-activation of the switching means is thus predefined by the threshold values I_{PosThresh} and I_{NegThresh}.

An optional D-flip-flop 30 can be used for the synchronisation and ensures that switching is not effected by means of the setting signal/set from one mode to the other during a switching process of switching means.

FIG. 7 shows the voltage characteristic Uₚ(t) and the current characteristic Iₚ(t) at the output of the inverter according to the invention and the threshold values I_{PosThresh} and I_{NegThresh} at which the de-activation release is effected. At the same time, the signal Ip90° is shown which is converted by the zero transition detection element 25 into the blocking signal Block, which changes over between the logic states ONE and ZERO.

FIG. 7a shows the phase response for a resonant oscillator circuit. With a specific phase angle Φ, which is settable or predefinable by means of the current threshold values I_{PosThresh} and I_{NegThresh}, an operating frequency f_{A} is set at which the current Iₚ oscillates. A phase angle Φ equal to ZERO produces an operating frequency of the inverter which is equal to the resonant frequency f₀ of the oscillator circuit. At a higher operating frequency f_{A}, an inductive phase position in relation to the resonant frequency f₀ can be achieved.

FIG. 8 shows the gate signal characteristics G1 to G4, the voltage potential characteristic at the points P1 and P2, the voltage Uₚ resulting thereon and the controlled current Iₚ. Until the time T₁, the inverter is in inverter mode A, in which the series oscillator circuit Ls. Cs is supplied with energy from the input voltage source U₁ in synchronism with the current Iₚ. At the time T₁, the current Iₚ exceeds the upper threshold value Iₚ₋ₘₐₓ, as a result of which the control device sets the setting signal/set to logical ONE. As a result, the de-activation release for the switching elements S₁ and S₃ is blocked so that the latter are activated. i.e. become conducting, but are no longer de-activated, i.e. can assume their blocking state, until mode B is cancelled or the setting signal I/set is reset once more to logical ZERO. After the setting signal/set is switched over to logic ONE, the switching elements S₁ and S₃ do not, however, become conducting until the current Iₚ has dropped below the predefined current threshold value or after the predefined dead time. During the time between T₁ and T₂, the switching elements S₁ and S₃ are thus conducting, as a result of which the series oscillator circuit L_{S}, C_{S} is short-circuited via the switching elements S₁ and S₃ and the voltage Uₚ is thus equal to ZERO. As a result, the current Iₚ freewheels, i.e. the oscillator circuit is no longer fed by the input voltage source Uᵢₙ, whereby the current Iₚ decreases. At the time T₂, the current Iₚ falls below the lower threshold value lₚ₋ₘᵢₙ, as a result of which the setting signal/set is set to logical ZERO and a de-activation would be possible at least due to the setting signal/set. Depending on the phase position and direction of the current Iₚ the switching elements S₁ to S₄ are again timed in synchronism with the current Iₚ from the time T₂ as a result of which the inverter again charges the oscillator circuit and the current Iₚ rises up to the upper threshold value Iₚ₋ₘₐₓ at the time T₃, whereupon switchover to mode B is again effected.

FIG. 9 shows two current-voltage diagrams for two different temporal durations of the modes A and B, wherein the pulse duty factor is the same. In the upper diagram, mode A extends temporally in each case over a full oscillation period and mode B in each case over two full oscillation periods. The pulse duty factor is thus 1:2.

If, as shown above, mode A is activated in each case for a full period, the intermediate circuit capacitor undergoes no DC offset and is thus less loaded. However, the disadvantage exists with a timing of this type that the control resolution is less than in the method shown in the lower diagram, in which mode A is active in each case for a half-oscillation period only, and mode B in each case for a full oscillation period. The pulse duty factor is 1:2 with this timing of the modes also. However, the intermediate circuit capacitor disadvantageously undergoes a DC offset.

FIG. 10 shows a schematic diagram of the control device for the inverter according to the invention according to FIG. 5a with a parallel oscillator circuit. The control device is structured along the lines of the control device according to FIG. 6, but with the difference that the switching elements are all active, i.e. are switched to a current-conducting state, during the overlap time in mode A so that the current can commutate from one bridge on to the other. Before the commutation is initiated, the switching elements of a diagonal are switched to a current-conducting state. The commutation is never initiated, i.e. the other hitherto blocking switching elements are never switched to a current-conducting state, until a specific negative voltage is exceeded on them, in particular the collector-emitter voltage falls below a specific threshold value. The comparators 17′ to 20′ serve to determine this voltage state. As soon as the threshold voltages U_{CE1}, U_{CE2}, U_{CE3}, U_{CE4} are understepped, the activation release signals are generated by means of the devices 6, 7, 10 and 11.

The control device generates the gate signals G1 to G4 for the switching means S₁ to S₄.

The gate signals G1 to G4 are generated by means of the flip-flops 1, 2, 3, 4 which are set or reset by means of the activation release signals 6, 7, 10, 11 and the de-activation release signals 5, 8, 9, 12. The de-activation release signals 5, 8, 9, 12 are determined by the characteristic of the current Uₚ so that the gate signals G1 to G4 control the switching means S₁ to S₄ in synchronism with the current Uₚ. To do this, the control device has two comparators 23′ and 26′ which determine the polarity of the voltage Uₚ on the basis of the predefined threshold values U_{PosThresh} and U_{NegThresh}. The output of the comparator 23′ which determines the positive voltage state of the voltage Up is connected to the AND gates 14 and 16 which generate the de-activation release signals 5, 9 for the switches S₂ and S₃. The output of the comparator 26′ which determines the negative voltage state of the voltage Uₚ, is connected to the AND gates 13 and 15 which generate the de-activation release signals 8, 12 for the switches S₁ and S₄.

The voltage Uₚ is integrated by means of the integrator 24′, as a result of which a signal Up90° is generated which is processed by a zero transition detection element 25′ to produce the blocking signal Block. The blocking signal Block is connected to an input of the AND gate 14′ and an input of the AND gate 16′. The blocking signal Block is simultaneously negated by means of the NOT gate 21 and is connected as _{B̅L̅O̅C̅K̅} to the inputs of the AND gates 13′ and 15′. The blocking signal Block and _{B̅L̅O̅C̅K̅} and the output signals of the comparators 23′ and 26′ are logically linked to one another by means of the AND gates 13′, 14′, 15′ and 16′ so that a de-activation release takes place for the respectively conducting switching means only if the voltage Uₚ has dropped below the threshold value U_{PosThresh} during the positive half-wave or has risen above the threshold value U_{NegThesh} during the negative half-wave. The phase angle for the de-activation of the switching means S1 to S4 is thus predefined by the threshold values U_{PosThresh} and U_{NegThresh}.

An optional D-flip-flop 30′ can be used for the synchronisation and ensures that switching is not effected by means of the setting signal/set from one mode to the other during a switching process of switching means.

In mode B, either the bridge arm S1-S2 is current-conducting and the other bridge arm S3 and S4 is switched to a blocking state so that the parallel oscillator circuit is decoupled from the current source I_{ic}. The voltage Uₚ drops while mode B is active. If the controller 22′ is designed as a two-step controller, switchback to mode A is effected as soon as the voltage Uₚ falls below a lower limit value. Mode A then remains active again until the voltage Uₚ has exceeded an upper limit value, after which the control device then switches to mode B.

The previously described control device cannot control the inverter correctly until the oscillator circuit has started to oscillate. Additional measures can therefore be taken which disable the control device for the time of the oscillation build-up. The oscillation build-up of oscillator circuits is already known from the prior art.

The integrator 24, 24′ will not supply a usable signal until the oscillator circuit has started to oscillate. It can be replaced during the oscillation build-up phase by an inverted differentiator. The latter provides a 90° phase shift, but is EMC-sensitive. It is therefore better for the stability of the circuit to switch over to integrator mode only as from a specific oscillator circuit current or a specific oscillator circuit voltage. Since the phase shift is used for signal blocking only, the integrator can be replaced with a constant dead-time element T_{dead} for a narrower frequency range. The inverter thus clocks in the oscillation build-up process over this operating time only and has the clock frequency f=1/T_{dead} until the other signals are generated from the current and voltage. This solution is simple in structure, but operates in a relatively smaller frequency interval only.

1. An inverter including:
at least two switching devices configured to feed a series oscillator circuit from a voltage source, and
a control device configured to control the switching devices in such a way that
in a first mode A, the inverter feeds the oscillator circuit via the switching means from the source, and
in a second mode B, the oscillator circuit is decoupled from the source,
wherein the control device is operative to switch back and forth between the two modes A and B to set a reference current in the oscillator circuit or a reference voltage on the oscillator circuit,
wherein, during operation to feed the series oscillator circuit from the voltage source, the control device is operative to deactivate or to release for deactivation at least one of the switching devices on reaching or understepping a predetermined current threshold value, or to adjust a control signal to de-activate at least one of the switching devices, wherein the current threshold values are selected in such a way that a switching frequency of control signals controlling the switching devices determines an operating frequency of the steady-state oscillator circuit in mode A, wherein a resonant frequency of the oscillator circuit is less than the switching frequency of the control signals, and
wherein the inverter includes a bridge circuit including two or four of the switching devices configured such that the inverter operates in mode A as a half-bridge, full-bridge, or push-pull inverter, and such that in mode B, the oscillator circuit operates in a freewheeling mode over at least a subset of the switching devices.

2. The inverter according to claim 1, the control device sets the reference current and the reference voltage over a pulse duty factor of the two modes A and B.

3. The inverter according to claim 1, wherein a, temporal duration throughout which one mode is active is equal to or is a multiple of a half-period duration of the resonant frequency of the oscillator circuit.

4. The inverter according to claim 1, wherein the inverter is inductive when feeding a series oscillator circuit.

5. The inverter according to claim 1, wherein the voltage source is a DC voltage source with a constant output voltage.

6. The inverter according to claim 1, wherein the control device is configured to activate a particular one of the switching devices or to change the control signal corresponding to the particular one of the switching devices to “ON” only if voltage decreasing on the particular one of the switching devices is equal to or close to zero or is equal to a threshold value, wherein a threshold value is assigned to each switching device or to a group of the switching devices.

7. The inverter according to claim 1, wherein the bridge circuit has an input connected to a constant input source and an output to which the oscillator circuit is connected.

8. The inverter according to claim 1, wherein the switching devices comprise semiconductor switches in the form of insulated gate bipolar transistors (IGBTs) or metal-oxide semiconductor field effect transistors (MOSFETs).

9. The inverter according to claim 1, wherein in mode B, the inverter represents a bipolar short circuit of the series oscillator circuit, so that a freewheeling of current flowing in the oscillator circuit is possible in both current directions over at least one oscillation period or at least a half-oscillation period.

10. The inverter according to claim 9, wherein the short circuit is implemented either via one of the switching devices in a conducting mode and a capacitor or via two of the switching devices in a conducting mode, wherein the respective other switching device or devices are in a blocking mode.

11. (canceled)

12. The inverter according to claim 1, wherein, in the case of the inverter having a series oscillator circuit connected to it on an output side, at least one voltage decreasing on a switching device is an input signal of the control device, and an actual current flowing through the oscillator circuit is a feedback variable for the control circuit, and a reference current is an input variable of a controller of the control device.

13. (canceled)

14. The inverter according to one of the preceding claims, characterised in that the control device generates de-activation release signals and activation release signals for the respective switching devices, from which it generates gate signals for the respective switching devices, wherein the gate signals are generated by means of respective RS-flip-flops, the activation release signals set the respective flip-flops, and the de-activation release signals reset the respective flip-flops.

15. The inverter according to claim 14, wherein the control device comprises two or four comparators configured to compare voltage levels at connection points in the inverter with a voltage threshold value or a plurality of voltage threshold values, wherein output signals of the comparators are used to generate the activation release signals.

16. The inverter according to claim 1, wherein the control device comprises two comparators configured to determine whether the current flowing through the oscillator circuit is less than a positive threshold value or greater than a negative threshold.

17. The inverter according to claim 1, wherein the control device comprises two comparators configured to determine whether a voltage across the oscillator circuit is less than a positive threshold value or greater than a negative threshold value.

18. The inverter according to claim 1, wherein the control device comprises a controller configured to generate a setting signal on the basis of a comparison of a reference variable with an actual variable.

19. The inverter according to claim 18, wherein the setting signal is a logical ONE if a measured actual current is greater than a predefined maximum current threshold value, and wherein the setting signal is a logical zero if the measured actual current falls below a minimum current threshold value.

20. The inverter according to claim 18, wherein the controller is a pulse-width modulation (PWM) or pulse sequence controller.

21. The inverter according to claim 1, wherein the control device comprises a device configured to generate a blocking signal to prevent a de-activation signal from being able to be generated during a positive half-wave only in the case of a negative increase in the current flowing through the oscillator or the voltage across the oscillator or during a negative half-wave only in the case of a positive increase in current for respectively current-conducting switching devices.

22. The inverter according to claim 21, wherein the control device uses the blocking signal to generate de-activation release signals.

23. The inverter according to claim 21, wherein the device comprises an integrator or a dead-time element.

24. The inverter according to claim 1, wherein the control device switches between modes A and B only if switching of the switching devices is completed.
